(19) United States
(12) Patent Application Publication
(10) Pub. No.: US 2006/0269445 A1
(43) Pub. Date: Nov. 30, 2006

(54) Method and system of testing tubular members for contaminates

(76) Inventors: Mark D. Basile, Grosse Pointe, MI (US); Martin Pfeifer, Waldkraiburg (DE); Ralph J. Basile, Sterling Heights, MI (US); Steven J. Basile, Gross Pointe Woods, MI (US)

Correspondence Address: BROOKS KUSHMAN P.C., 1000 TOWN CENTER, TWENTY-SECOND FLOOR, SOUTHFIELD, MI, 48075, US

(21) Appl. No.: 11/136,062

(22) Filed: May 24, 2005

(51) Int. Cl. G01N 31/22

(52) U.S. Cl. 422/58

(57) ABSTRACT

A method and system of testing tubular member for contaminates. A testing prod may be used to collect particles from within the tubular member. A testing agent may be used to indicate whether the tubular member is contaminated as a function of the collected particles.

### BACKGROUND OF THE INVENTION

1. Field of the Invention

The present invention relates to testing tubular members for contaminates.

2. Background Art

Tubular medical devices, such as endoscopes, may be used for any number of medical procedures. The tubular members may be inserted within a body through an incision or other opening so that surfaces at or near the inserted end of the tubular member may be viewed. Such devices may be contaminated by particles or other materials, such as mucous, saliva, blood, pieces of tissue, and the like. Before reuse of such tubular members, it may be advantageous to test for the presence of such contaminates.

### SUMMARY OF THE INVENTION

One non-limiting aspect of the present invention relates to system of testing a lumen of a cannula of an endoscopic medical device. The system may include an elongated, flexible, semi-rigid prod configured to fit with the lumen and comprising a material suitable for non-destructive movement within the lumen. The system may include a swab at one end of the prod which may be sufficiently sized to contact sides of the lumen in such as manner as to collect particles included therein. The system may include an activating vial for storing an activating agent and a testing vial for storing an indicating agent. The testing vial may be sufficiently sized to receive the swab and the activating agent may be added to the indicating agent within the testing vial, prior to receipt of the swab, so that the agents react with the collected particles to indicate whether the collected particles are contaminates, and thereby, indicate whether the tubular member is contaminated.

The system may include the activating and indicating agents being fluids that change color to indicated whether the particles are contaminates, such as blood residue.

Another aspect of the present invention relates to system of testing tubular members for contaminates. The system may include a testing prod having a material collection unit at at least one end which may fit within the tubular member to sample materials included therein. The system may include a testing unit configured to receive the material collection unit and to indicate if the sampled materials are contaminates.

The testing unit may include an indicting agent and the system may include an activating unit having an activating agent. The testing unit and activating agents may be separate units such that the activating agent may be delivered from the activating unit into the testing unit to activate the indicating agent. The activated indicator unit thereafter may be suitable for indicating whether the sampled materials are contaminates.

Yet another non-limiting aspect of the present invention relates to a method of testing a tubular member for contaminates. The method may include inserting a testing prod having a collection unit at one end into the tubular member, moving the collection unit within the tubular member to collect particles included therein, and exposing the collection unit to a testing agent which indicates whether the collected particle are contaminates, and thereby, indicate whether the tubular member is contaminated.

The method may include removing the collection unit from the end of the testing prod and inserting the removed collection unit within a testing vial having the testing agent, and shaking the testing vial having the testing agent and the collection unit so as to cause the testing agent to react with the collected particles, whereby the reaction of the testing agent with the collected particles indicating whether the collected particle are contaminates, and thereby, indicate whether the tubular member is contaminated.

The method may include spraying the collection unit with the testing agent and/or dipping the collection unit into the testing agent.

Yet another aspect of the present invention relates to system for testing a tubular member for contaminates. The system may include a testing prod having a collection unit. The testing prod and collection unit being configured to fit within the tubular member and to collect particles included therein. The system may include a testing agent operable with the collection unit to indicate whether the collected particles are contaminates, and thereby, indicate whether the tubular member is contaminated.

The above features and advantages, along with other features and advantages of the present invention, are readily apparent from the following detailed description of the invention when taken in connection with the accompanying drawings.

### BRIEF DESCRIPTION OF THE DRAWINGS

FIG. 1 illustrates a testing prod in accordance with one non-limiting aspect of the present invention;

FIG. 2 illustrates a testing vial in accordance with one non-limiting aspect of the present invention;

FIG. 3 illustrates an activating vial in accordance with one non-limiting aspect of the present invention;

FIG. 4 illustrates the testing vial receiving a collection unit in accordance with one non-limiting aspect of the present invention;

FIG. 5 illustrates shaking of the testing vial in accordance with one non-limiting aspect of the present invention; and

FIGS. 6-8 illustrate a color change of a testing fluid in accordance with one non-limiting aspect of the present invention.

### DETAILED DESCRIPTION OF THE PREFERRED EMBODIMENT(S)

FIG. 1 illustrates a testing prod 10 in accordance with one non-limiting aspect of the present invention. The testing prod 10 may be inserted within tubular members to sample, collect, or otherwise retain particles included therein. It may include a collection unit 14 at at least one end thereof to collect such particles. A portion 16 of the testing prod 10 may be resiliently flexible so as to facilitate moving the collection unit 14 through the tubular member.

The flexible portion 16 may include a resiliently flexible cable or similar feature encapsulated in medically approved plastic, rubber, or other synthetic or non-synthetic material. The structure and material composition of the testing prod 10 may dependent on a composition of the tubular member and selected accordingly so as to permit non-destructive movement through the tubular member. Of course, the present invention is not intended to be limited to a flexible member and fully contemplates the use of more or less resilient members, and even, rigid members.

The collection unit 14 may be a swab, brush, or other feature configured to sample particles from within the tubular member. It may be configured with a diameter suitable for contacting one or more sides of the tubular member when moved therethrough. The collection unit 14 may be generally tear-shaped with a uniform cross-section so as to facilitate ease of movement and to compress circumferentially around a circular, tubular member.

The testing prod 10 may be used in any number of environments to test for contaminates. For example, the testing prod 10 may be configured for insertion within a lumen of a cannula of an endoscopic medical device, such as an endoscope. Of course, the present invention fully contemplates any number of applications and is non intended to be limited to endoscopic devices or other medical equipment. Rather, the present invention contemplates any number of applications where it is desirable to sample particles from a tubular member.

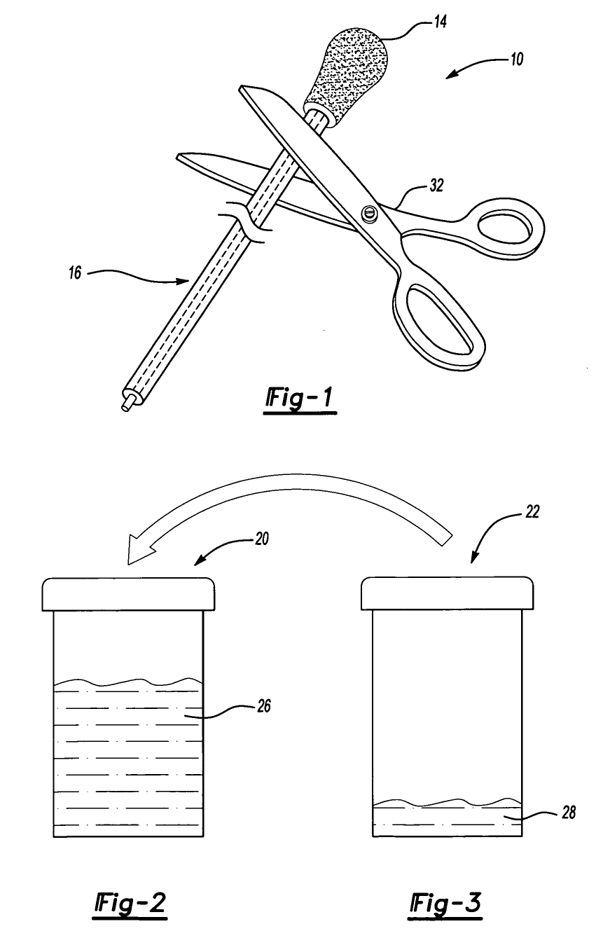

FIGS. 2-3 illustrate a testing vial 20 and an activating vial 22 in accordance with one non-limiting aspect of the present invention. The vials 20-22 may be use in combination with the testing prod to provide a system of testing tubular members. In more detail, the testing vial 20 may include an indicating fluid 26 and the activating vial 22 may include an activating fluid 28.

The fluids may be kept in separate containers due to instability. For example, if the fluids are mixed, there may be a limited period of time within which the testing fluid will be able to change colors or perform other operations to indicate contamination of the swab. Transporting the fluids in separate containers allows the user to select an appropriate time to mixing the fluids. The activating fluid 28 may be poured into the testing vial 20 for activating the indicating fluid. Of course, however, the present invention is not so limited and fully contemplates single vial applications with suitable fluids.

The activated indicating fluid (testing fluid) may be used to test the particles collected with the collection unit 14. As shown in FIG. 1, the collection unit 14 may be removed or otherwise detached from the testing prod, such as with scissors 32 or other cutting utensil. The flexible portion 16 may be suitable configured to support detaching the collection unit 14 in this manner. Of course, however, the present invention fully contemplates other configurations for supporting detachment of the collection unit 14, such as by modifying the flexible portion 16 to include a clip, fastener, or other feature.

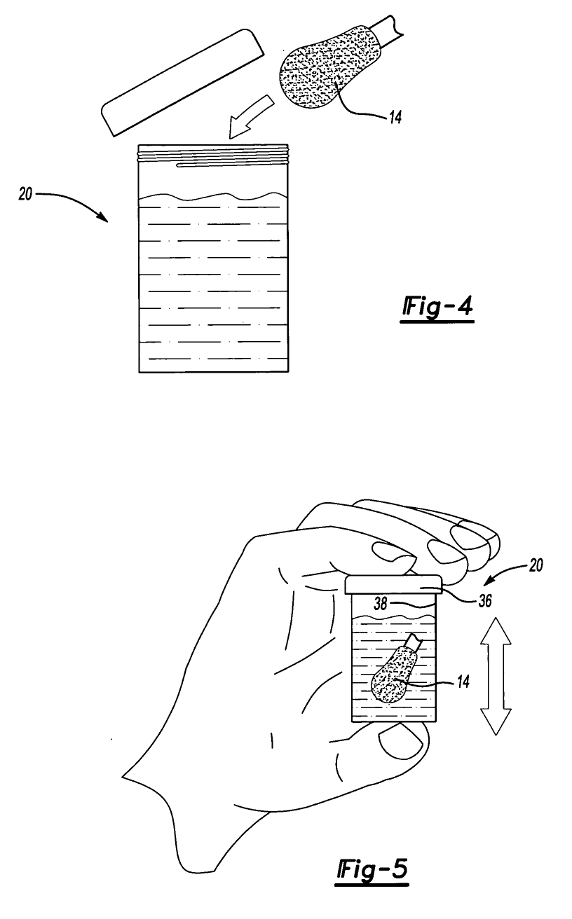

Once removed, the collection unit 14 may be received within the testing vial 20, as shown in FIG. 4. As shown in FIG. 5, the testing vial 20 may include a cover 36 over an enclosure 38 receiving the collection unit 14. The cover 36 may be sufficient to retain the testing fluid and the swab so that the testing vial may be shaken without leaking the testing fluid.

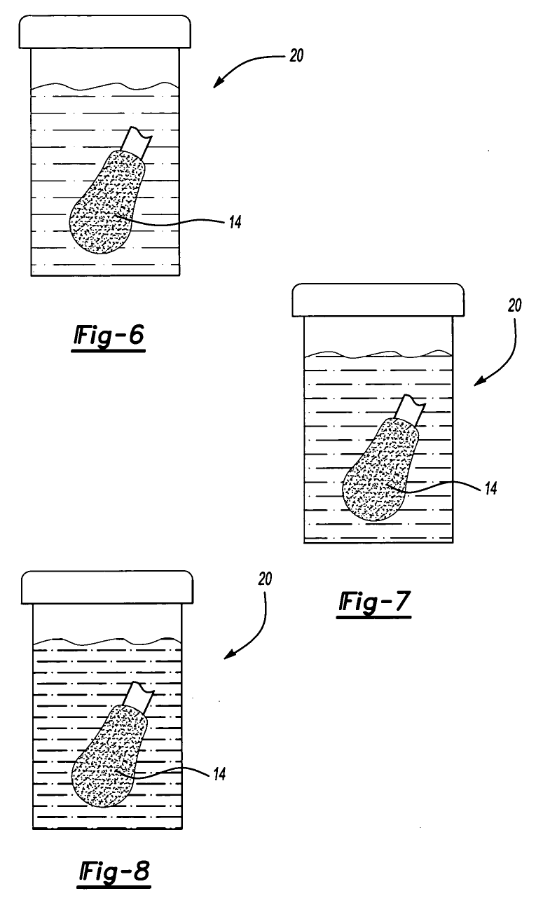

The testing fluid may be mixed with particles collected by the collection unit 14. A color of the testing fluid may change to indicate whether the collected particles are contaminates. FIG. 6 illustrates the testing fluid having a relatively clear coloring, indicative of no or insignificant amounts of contaminates within the tubular member. FIG. 7 illustrates the testing fluid having a blue-green color, indicative of a slight amount of contaminates within the tubular member. FIG. 8 illustrates the testing fluid having a dark blue color, indicative of a strong amount of contaminates within the tubular member.

The degree of color change may be of assistance in assessing the degree of contamination of the tubular member. Of course, the present invention is not intended to be limit to the foregoing color changes. Rather, the present invention fully contemplates using any number of color change sequences, including binary operations where the color changes only once if there are contaminates within the tubular member.

Moreover, the present invention fully contemplates testing for any number of contaminates within the tubular member. For example, the testing fluid may be suitable selected and configured to test for blood residue within the tubular member. The presence and strength of such blood residue may be indicated with the color changes shown in FIGS. 6-8. In another example, the testing fluid may be configured to change different colors, depending on the type of contamination. This type of dual-purpose testing fluid may be advantageous in environments where testing for other residues may be desirable.

Likewise, other testing operations besides color changes may be used to indicate contaminates. For example, other detectable changes such as pH change, light emission, gas or precipitate building up, and the like are contemplated. The present invention also contemplates other applications where the collection unit 14 may not require detachment from the flexible portion 16. For example, a testing fluid or substance may be applied directly to the collection unit 14 for indicating contaminates, such as by spraying a substance on the collection unit 14 and/or dipping the collection unit 14 into a fluid or other substance.

As described above, the present invention provides a testing system which may be used to test tubular members, such as endoscopes and other medical devices. One aspect of the system that is advantageous is that it may be generally low cost, disposable, and used on-site for immediate results. It allows technicians and other personal to quickly check for contaminates in an easy manner, and optionally, without having to culture the sample particles.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A system of testing a lumen of a cannula of an endoscopic medical device, the system comprising:
an elongated, flexible, semi-rigid prod configured to fit with the lumen and comprising a material suitable for non-destructive movement within the lumen;
a swab at one end of the prod and sufficiently sized to contact sides of the lumen in such as manner as to collect particles included therein;
an activating vial for storing an activating agent; and
a testing vial for storing an indicating agent, the testing vial being sufficiently sized to receive the swab, the activating agent being added to the indicating agent within the testing vial prior to receipt of the swab, the testing vial including a cover to secure the swab within an enclosure having the activating and indicating agents such that the testing unit may be shaken without leaking the agents, the agents reacting with the collected particles to indicate whether the collected particles are contaminates, and thereby, indicate whether the tubular member is contaminated.

2. The system of claim 1 wherein the activating and indicating agents are fluids and a color of the fluids indicates whether the collected particles are contaminates.

3. The system of claim 2 wherein the color of the fluids indicates whether blood residue was found within the endoscopic medical device.

4. The system of claim 3 wherein the color of the fluids changes according to an amount of blood residue found within the endoscopic medical device.

5. A system of testing tubular members for contaminates, the system comprising:
a testing prod having a material collection unit at at least one end, the prod being configured to fit the material collection unit within the tubular member to sample materials included therein; and
a testing unit configured to receive the material collection unit, the testing unit including capabilities to indicate if the sampled materials are contaminates.

6. The system of claim 5 wherein the testing unit includes an indictor agent and the system further comprises an activating unit having an activating agent, the testing unit and activating agents being separate units, the activating agent being delivered from the activating unit into the testing unit to activate the indicating agent, the activated indicator unit thereafter being suitable for indicating whether the sampled materials are contaminates.

7. The system of claim 6 wherein the activating and indicating agents are fluids and the activating and testing units are configured to facilitate pouring the activating agent from the activator unit into the testing unit.

8. The system of claim 5 wherein the testing unit includes an enclosure having a testing agent, wherein the collection unit is exposed to the testing agent within the enclosure, the testing agent indicating whether the sampled materials are contaminates.

9. The system of claim 8 wherein the testing agent includes an activating agent and an indicating agent, the activating agent being added to the indicating agent prior to receiving the collection unit.

10. The system of claim 8 wherein the testing unit includes a cover over the enclosure such that the collection unit is received within the enclosed and covered by the cover to permit the testing unit to be shaken so as to cause the testing agent to mix with the sampled materials.

11. The system of claim 5 wherein the prod includes a resiliently flexible portion to facilitate guiding the material collection unit through the tubular member.

12. The system of claim 11 wherein the testing unit is configured to receive the material collection unit portion of the prod and not the resiliently flexible portion.

13. The system of claim 12 further comprising a tool for detaching the material collection unit from the testing prod so that the detached material collection may be received within the testing unit.

14. The system of claim 13 wherein the tool is a cutting implement configured to cut the testing prod.

15. The system of claim 15 wherein the tool is part of the testing unit.

16. The system of claim 5 wherein the material collection unit is a swab.

17. The system of claim 5 wherein the tubular member is associated with an endoscope and the testing prod is sufficiently sized such that it may be pushed through one and out the other end of the endoscope to test and sample materials included therein.

18. A method of testing a tubular member for contaminates, the method comprising:
inserting a testing prod having a collection unit at one end into the tubular member;
moving the collection unit within the tubular member to collect particles included therein; and
exposing the collection unit to a testing agent, the testing agent indicating whether the collected particle are contaminates, and thereby, indicate whether the tubular member is contaminated.

19. The method of claim 18 further comprising:
removing the collection unit from the end of the testing prod and inserting the removed collection unit within a testing vial, the testing vial having the testing agent; and
shaking the testing vial having the testing agent and the collection unit so as to cause the testing agent to react with the collected particles, the reaction of the testing agent with the collected particles indicating whether the collected particle are contaminates, and thereby, indicate whether the tubular member is contaminated.

20. The method of claim 18 further comprising:
spraying the collection unit with the testing agent.

21. The method of claim 18 further comprising:
dipping the collection unit into the testing agent.

22. The method of claim 18 further comprising:
varying a color of the testing agent as a function of whether the collected particles are contaminates.

23. A system for testing a tubular member for contaminates, the system comprising:
a testing prod having a collection unit, the testing prod and collection unit being configured to fit within the tubular member and to collect particles included therein; and
a testing agent operable with the collection unit to indicate whether the collected particles are contaminates, and thereby, indicate whether the tubular member is contaminated.

24. The system of claim 23 further comprising:
a testing vial having the testing agent and being configured to receive at least a portion of the collection unit for mixing with the testing agent, the testing agent changing appearance if the collected particles are contaminates.

25. The system of claim 24 wherein the collection unit is detached from the testing prod for receipt within the testing vial such that the testing prod and collection unit are disposable, single-use items.

26. The system of claim 24 wherein the testing vial is configured to received the collection unit if the collection unit is attached to the testing prod such that the collection unit may be dipped into the testing fluid.
